(19) United States
(12) Patent Application Publication
(10) Pub. No.: US 2026/0157262 A1
(43) Pub. Date: Jun. 11, 2026

(54) PLANTING APPARATUS

(71) Applicant: Mechanical Transplanter Company, L.L.C., Holland, MI (US)

(72) Inventors: Daniel Lee Timmer, Hamilton, MI (US); Erik Lee Vanappledorn, Holland, MI (US)

(73) Assignee: Mechanical Transplanter Company, L.L.C., Holland, MI (US)

(21) Appl. No.: 19/408,696

(22) Filed: Dec. 4, 2025

Related U.S. Application Data
(60) Provisional application No. 63/728,867, filed on Dec. 6, 2024.

(51) Int. Cl. A01C 5/06; A01C 7/20

(52) U.S. Cl. CPC A01C 5/06; A01C 7/20

(57) ABSTRACT

A planting apparatus having an adjustable cam assembly. The adjustable cam assembly includes a hollow shaft, a first cam, and a first arm. The hollow shaft includes a first end and a second end. The first arm adjustably couples the hollow shaft and the first cam to provide multiple stitch lengths.

### CROSS-REFERENCE TO RELATED APPLICATION(S)

This application claims priority to U.S. Provisional Patent Application No. 63/728,867, filed Dec. 6, 2024, which is incorporated herein by reference in its entirety.

### TECHNICAL FIELD

The present subject matter relates generally to a planting apparatus, more specifically a planting apparatus for producing a series of stitches that receive at least one seed or a seedling.

### BACKGROUND

One type of planting apparatus generates a series of stitches, where each stitch is a hole or slot in the ground that receives one or more seeds or a seedling. However, different seeds or seedlings require different spacing. Traditionally, for planting apparatuses that generate a series of stitches, in order to change the spacing for a different kind of seed or seedling, the entire planting apparatus has to be changed, or at least components of the planting apparatus have to removed and replaced with different components to obtain different distances between the stitches as required for appropriate seed spacing.

### BRIEF DESCRIPTION OF THE DRAWINGS

In the drawings:

FIG. 1 is a perspective view of a planting apparatus in accordance with various aspects described herein.

FIG. 2 is a schematic view of an adjustable cam assembly at a first stitch length in a first position for use in the planting apparatus of FIG. 1 in accordance with various aspects described herein.

FIG. 3 is a schematic view of the adjustable cam assembly at the first stitch length of FIG. 2 in a second position in accordance with various aspects described herein.

FIG. 4 is a schematic view of an adjustable cam assembly at a second stitch length in a first position, and a delivery assembly for use in the planting apparatus of FIG. 1 in accordance with various aspects described herein.

FIG. 5 is a schematic view of the adjustable cam assembly at the second stitch length, and the delivery assembly of FIG. 4 in a second position in accordance with various aspects described herein.

FIGS. 6-11 are schematic views of the adjustable cam assembly of FIG. 4 and FIG. 5 at various positions between the first position of FIG. 4 and the second position of FIG. 5 in accordance with various aspects described herein.

FIG. 12 is a schematic view of an adjustable depth assembly for the planting apparatus of FIG. 1 in accordance with various aspects described herein.

FIG. 13 is a flow chart illustrating a method of adjusting the planting apparatus of FIG. 1.

### DETAILED DESCRIPTION

As used herein, a “stitch” is a slot or hole in the ground for planting at least one seed or a seedling. As used herein, the term “seed” refers to an object that could potentially germinate into a seedling. As used herein, the term “seedling” refers to a plant that has not matured or is not full grown.

A stitch is created by a dibble, piercing tine, hammer, or other ground piercing device that enters and exits the soil, leaving a hole, slot, or divot. A stitch includes a stitch depth measured from a top surface of the soil to a lowest point within the soil. That is, a stitch is a finite opening in the soil resulting from a planting apparatus or tool. One or more seeds, such as in a range of 1 to 4 seeds, can be placed in the stitch, however any number of seeds is contemplated. Alternatively, a seedling can be placed or transplanted into the stitch.

To plant a row of crops, a series of stitches that are uniformly spaced from each other by a stitch length, are utilized. The stitch length is measured between two adjacent or consecutive stitches of the series of stitches. The stitch length is measured from a leading edge of a first stitch to a leading edge of a second stitch. Alternatively, the stitch length can be measured from a geometric center of the first stitch to a geometric center of the second stitch, where the first and second stitches are adjacent or consecutive in the series of stitches.

It is important to note that a stitch is not a horizontal trough generated, for example, from angled discs, beams, drag tines, or other sharp objects pulled horizontally through the soil. Rather, a stitch is made by a vertical puncture or piecing of the soil, where the plurality of stitches are spaced from each other horizontally by the stitch length.

Some planting devices are capable of providing a series of stitches, but only provide a single distance between the stitches. In order to obtain a different stitch length between the stitches to plant a different type requiring the different stitch length, either the planting device or significant portions of the planting device have to be removed or replaced.

Aspects of the disclosure described herein are directed to a planting apparatus that generates a series of stitches. The planting apparatus includes an adjustable cam assembly that allows the planting apparatus to provide multiple stitch lengths, such as without adding or removing components. The adjustable cam assembly includes a hollow shaft that drives the production of the stitch, a first cam, and a first arm. The first arm is adjustable such that the planting apparatus can generate a first series of stitches at a first stitch length when the first arm is in a first location relative to the first cam and a second series of stitches at a second stitch length when the first arm is in a second location relative to the first cam.

The planting apparatus, as described herein having different stitch lengths without the need for additional materials, meets a long-felt need in the industry. The planting apparatus, as disclosed, allows a user to plant a wide variety of plant types, as the stitch length can be adjusted, for example, from 2 inches to 30 inches, without additional planting devices, additional attachments, or intense reworking of the planting apparatus.

The planting apparatus is capable of generating the series of stitches in various types of soil. There are additional benefits to planting using the series of stitches when planting in soil with a protective barrier (e.g., plastic mulch). The protective barrier has many benefits including, but not limited to, controlling moisture in the soil, functioning as a weed deterrent, and reducing effects of airborne plant diseases. Planting in soil with a protective barrier presents a different set of challenges, making a planting device capable of producing a series of stitches desirable. In order to plant seeds or seedlings, the protective barrier is punctured, and the seed or seedling is placed through the punctured portion of the protective barrier into the soil. The planting apparatus, according to various aspects disclosed here, can generate the series of stitches without materially damaging the protective barrier. In contrast, some other designs, such as trough planting apparatuses, would simply split open the plastic barrier, defeating the benefits of the plastic barrier.

As may be used herein, the terms “first,” “second,” or “third” may be used interchangeably to distinguish one component from another and are not intended to signify location or importance of the individual components.

All directional references (e.g., upper, lower, left, right, front, back, top, bottom, above, below, vertical, horizontal, upstream, downstream, forward, aft, etc.) are only used for identification purposes to aid the reader's understanding of the present disclosure, and do not necessarily create limitations, particularly as to the position, orientation, or use of aspects of the disclosure described herein. Directional references in the figures are given with reference to a floor on which at least a portion of the pallet assembly rests.

Connection references (e.g., attached, coupled, and connected) are to be construed broadly and can include intermediate structural elements between a collection of elements and relative movement between elements unless otherwise indicated. As such, connection references do not necessarily infer that two elements are directly connected and in fixed relation to one another. The exemplary drawings are for purposes of illustration only. The dimensions, positions, order, and relative sizes reflected in the drawings attached hereto can vary.

The singular forms “a”, “an”, and “the” include plural references unless the context clearly dictates otherwise. Furthermore, as used herein, the term “set” or a “set” of elements can be any number of elements, including only one.

Uses of “and” and “or” are to be construed broadly. For example, and without limitation, uses of “and” do not necessarily require all elements or features listed, and uses of “or” are inclusive unless such a construction would be illogical.

The term “parallel” refers to generally parallel, where first and second lines extend such that a third line can be drawn that crosses the first and second lines, wherein the third line is in a range of 80 degrees to 100 degrees to both the first line and the second line.

As used herein, the term “series” means one right after another. For example, the series of stitches form a plurality of holes, one right after another spaced apart by a predetermined stitch length to form a line of or row of holes in which to plant seeds or seedlings. The lines or rows can be parallel, with a field having several lines or rows.

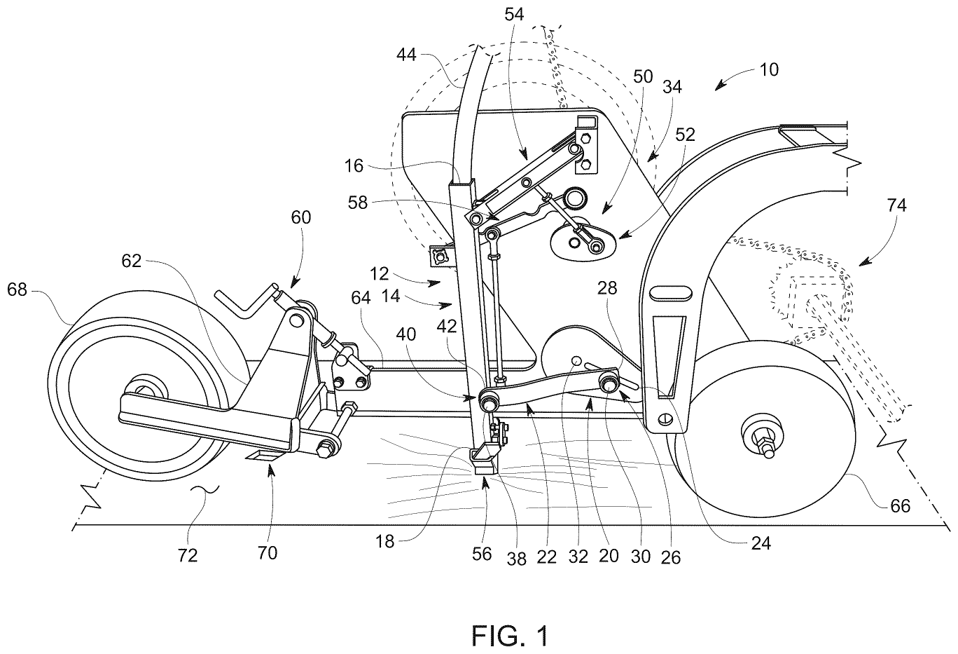

FIG. 1 illustrates a planting apparatus 10 according to a non-limiting example. The planting apparatus 10 includes an adjustable cam assembly 12. The adjustable cam assembly 12 can include, among other things, a hollow shaft 14 having a first end 16 and a second end 18, a first cam 20, and a first arm 22. The first arm 22 adjustably couples the hollow shaft 14 and the first cam 20, such as to provide multiple stitch lengths. The adjustable coupling of the first cam 20 and the first arm 22 is illustrated, by way of example, as including a slot 24 defined by the first cam 20, and a fastener assembly 26 that rotatably couples a first end 28 of the first arm 22 to the first cam 20 at the slot 24. The fastener assembly 26 can be loosened to allow the location of the first end 28 of the first arm 22 to slide or otherwise change locations within the slot 24. That is, when the fastener assembly 26 is in a locked or secure position, the first end 28 of the first arm 22 maintains its location within the slot 24. The fastener assembly 26 can include a rotatable device, such as a bushing. When in a locked or secure position, the first arm 22 can rotate about a pivot illustrated as a first point of rotation 30 defined by the fastener assembly 26 while maintaining location relative to the slot 24. For example, the first point of rotation 30 can be fixed via the fastener assembly 26 at various positions along the slot 24, and the first cam 20 can rotate relative to the first arm 22 about the first point of rotation 30. The first point of rotation 30 is translating a point of rotation relative to a frame 34 supporting the planting apparatus 10. That is, during operation of the planting apparatus 10, the first arm 22 and the first cam 20 are rotatably coupled at the first point of rotation 30, however the first point of rotation 30 can linearly translate relative to the frame 34.

While illustrated as having the slot 24 defined by the first cam 20, and the fastener assembly 26 that rotatably and selectively couples a first end 28 of the first arm 22 to the first cam 20, other adjustable couplings between the first cam 20 and the first arm 22 are contemplated.

A pivot illustrated as a second point of rotation 32 is defined by the first cam 20. The frame 34 supports the first cam 20 at the second point of rotation 32 such that the first cam 20 is rotatable about the second point of rotation 32 relative to the frame 34. The second point of rotation 32 is a fixed point of rotation. That is, the second point of rotation 32 does not linearly translate relative to the frame 34 during operation of the planting apparatus 10.

The frame 34 can include a plurality of metal plates, as illustrated. However, the frame 34 can include any number of beams, pipes, or other support structures to which at least the first cam 20 can be rotatably supported or coupled.

The first arm 22 is rotatably coupled to the hollow shaft 14 at a third point of rotation 38. The third point of rotation 38 can be defined by a fastener assembly 40. The fastener assembly 40 can maintain the location of the third point of rotation 38 relative to the hollow shaft 14, while allowing a second end 42 of the first arm 22 to rotate. That is, the distance between the fastener assembly 40 and the first end 16 or the second end 18 of the hollow shaft 14 is maintained during operation of the planting apparatus 10. The third point of rotation 38 is translating point of rotation relative to the frame 34.

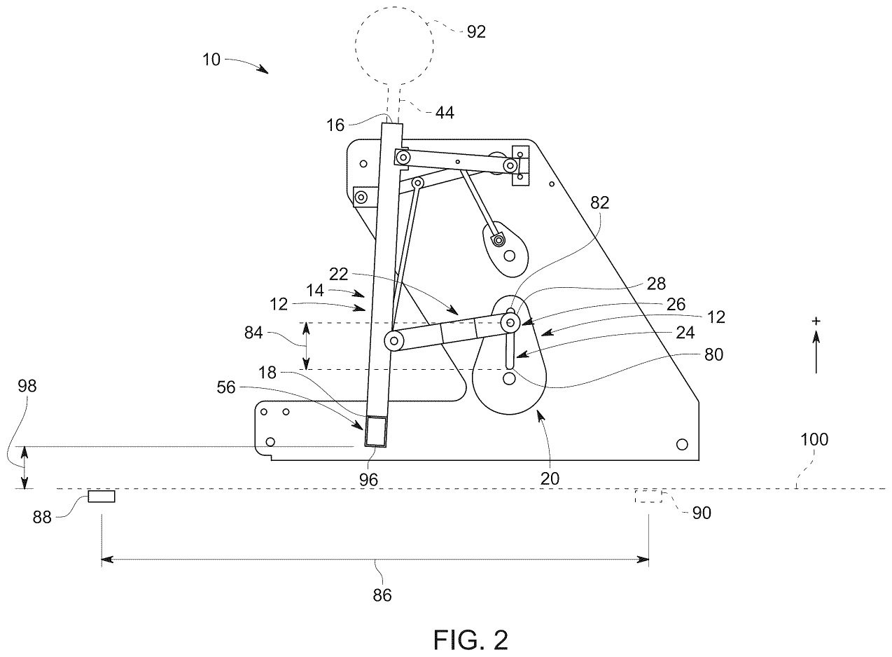

The hollow shaft 14 can receive a conduit 44. The conduit 44 can couple to one or more seed metering devices. By way of non-limiting example, a seed metering device 92 (FIG. 2) can provide a seed to the conduit 44 based on a predetermined frequency. Additionally, or alternatively, the seed metering device or devices can provide more than one seed with a predetermined frequency to the conduit 44.

Alternatively, the hollow shaft 14 can couple to one or more components to receive a seedling to be transplanted into a stitch. The seedling metering system can include, but is not limited to, a clamshell, a cup, one or more doors, a point, or gate.

The planting apparatus 10 can include a delivery assembly 50. The delivery assembly 50 can include a second cam 52, a second arm 54 operably coupling the second cam 52 and the hollow shaft 14, a gate 56 located at the second end 18 of the hollow shaft 14, and a timing arm 58 operably coupled to the gate 56.

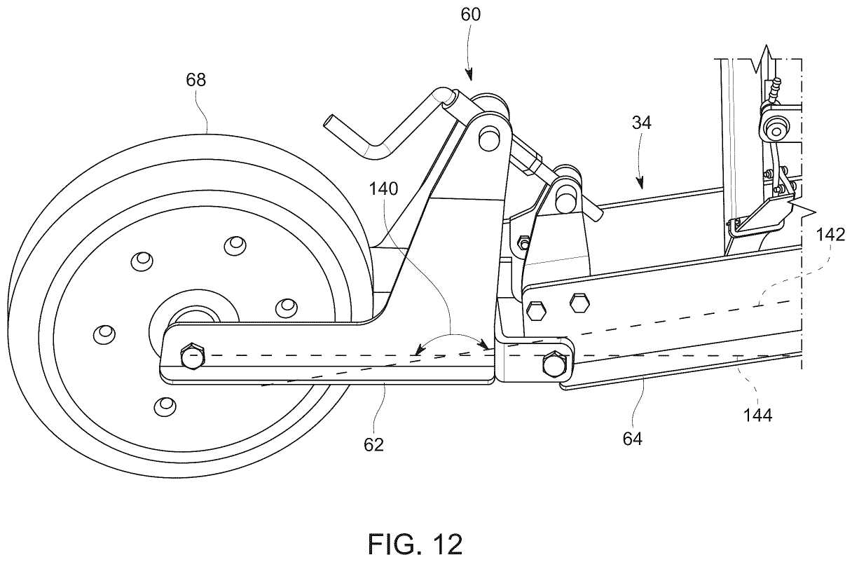

The planting apparatus 10 can include an adjustable depth assembly 60. The adjustable depth assembly 60 can change the position of a rear portion 62 of the frame 34 and a main portion 64 of the frame 34. For example, the adjustable depth assembly 60 can change the angle (FIG. 12) between the rear portion 62 of the frame 34 and the main portion 64 of the frame 34.

A front wheel 66 can be rotatably coupled to the main portion 64 of the frame 34. That is, the front wheel 66 is coupled to the main portion 64 such that the front wheel 66 can rotate relative to the main portion 64. Alternatively, it is contemplated that the front wheel 66 can be supported by one or more components coupled to the main portion 64 of the frame 34.

A rear wheel 68 can be rotatably coupled to the rear portion 62 of the frame 34. That is, the rear wheel 68 is coupled to the rear portion 62 such that the rear wheel 68 can rotate relative to the rear portion 62. Alternatively, it is contemplated that the rear wheel 68 can be supported by one or more components coupled to the rear portion 62 of the frame 34.

The planting apparatus 10 can include a driving assembly 74. Optionally, the driving assembly 74 can include one or more of a drive wheel, chain, shaft, hydraulic motor, gear assembly, or gear train. The driving assembly 74 can operably rotate at least one of the first cam 20 or the second cam 52. It is also contemplated that the driving assembly 74 includes components capable of coupling or driving the second cam 52 based on the rotation of the first cam 20. It is further contemplated that the driving assembly 74 can include various components configured to transfer rotational energy, linear energy, or both from one component of the planting apparatus 10 to another component of the planting apparatus 10.

While operable in various soil types, the planting apparatus 10 is illustrated as generating a series of stitches 70 in the ground through a protective barrier 72.

FIG. 2 depicts a schematic view of a portion of the planting apparatus 10. More specifically, FIG. 2 illustrates the adjustable cam assembly 12 in a first position. As illustrated, by way of example, the first cam 20 defines the slot 24 that includes a first slot end 80 and a second slot end 82. The first end 28 of the first arm 22 couples to the first cam 20 at the slot 24 by the fastener assembly 26. The position of the first end 28 of the first arm 22 relative to the slot 24 determines a stitch length, illustrated as a first stitch length 86.

A slot distance, illustrated as the first slot distance 84, is measured from the fastener assembly 26 to the first slot end 80. The first slot distance 84 corresponds to the first stitch length 86. That is, the position of the coupling of the first cam 20 and the first arm 22 along the slot 24 determines the first stitch length 86.

To ease understanding, the first stitch length 86 is illustrated between a geometric center of a first stitch 88 already produced by the planting apparatus 10 and a geometric center of a second stitch 90 illustrated, by way of example, as the next stitch to be produced by the planting apparatus 10. In other words, the first stitch length 86 is measured between adjacent stitches. It is contemplated that the first stitch length 86 can be measured from the leading edge or trailing edge of the first stitch 88 to a corresponding leading edge or trailing edge of the second stitch 90, where the first stitch 88 and the second stitch 90 are consecutive or adjacent stitches.

When the adjustable cam assembly 12 is in the first position, the gate 56 is in a closed position. When the gate 56 is in the closed position, the seed metering device 92 provides one or more seeds to the closed gate 56. The one or more seeds can pass through any number of passages or conduits, illustrated as conduit 44, that couple the seed metering device 92 to the first end 16 of the hollow shaft 14. For example, the seed metering device 92 can be configured to provide one, two, or three seeds to the hollow shaft 14 when the gate 56 is in the closed position.

Optionally, the seed metering device 92 can include a timing device located within the seed metering device 92, coupled to the seed metering device 92, or a combination thereof. The timing device can control the number of seeds, when the one or more seeds are released to the conduit 44 or the hollow shaft 14, or any combination thereof. That is, one or more components can be added to the seed metering device 92 to control the number of seeds and when those seeds will be dropped into the conduit 44, the hollow shaft 14, or another component that is coupled to the conduit 44 or the hollow shaft 14. The timing device can be, for example, a seed plate.

A hollow interior of the hollow shaft 14 defines a passage coupling the first end 16 and the second end 18 of the hollow shaft 14. That is, the one or more seeds can pass through the hollow shaft 14 from the first end 16 to the second end 18. The second end 18 is coupled to the gate 56, which can receive the one or more seeds when in the closed position. The gate 56 includes a sharpened tip 96. The sharpened tip 96 can include multiple sharpened portions of the gate 56.

A distance 98 can be measured from a surface reference line 100 to the sharpened tip 96 or the first end 16 of the hollow shaft 14. The surface reference line 100 is defined by the ground vertically beneath the sharpened tip 96 or the first end 16 of the hollow shaft 14. When in the first position, the sharpened tip 96 is above surface reference line 100, assuming the upward direction to be a positive direction, the distance 98 is greater than zero. That is, when the adjustable cam assembly 12 is in the first position, the distance 98 is a positive non-zero number.

Optionally, the first position can be defined at a maximum retraction at a maximum positive value of the distance 98. That is, the highest point of the upstroke of the hollow shaft 14 and the gate 56 in which the upward motion changes to a downward motion can define the first position. It is contemplated that any part of the stroke of the hollow shaft 14 and the gate 56 in which the gate 56 is closed and the distance 98 is a positive value can be considered the first position.

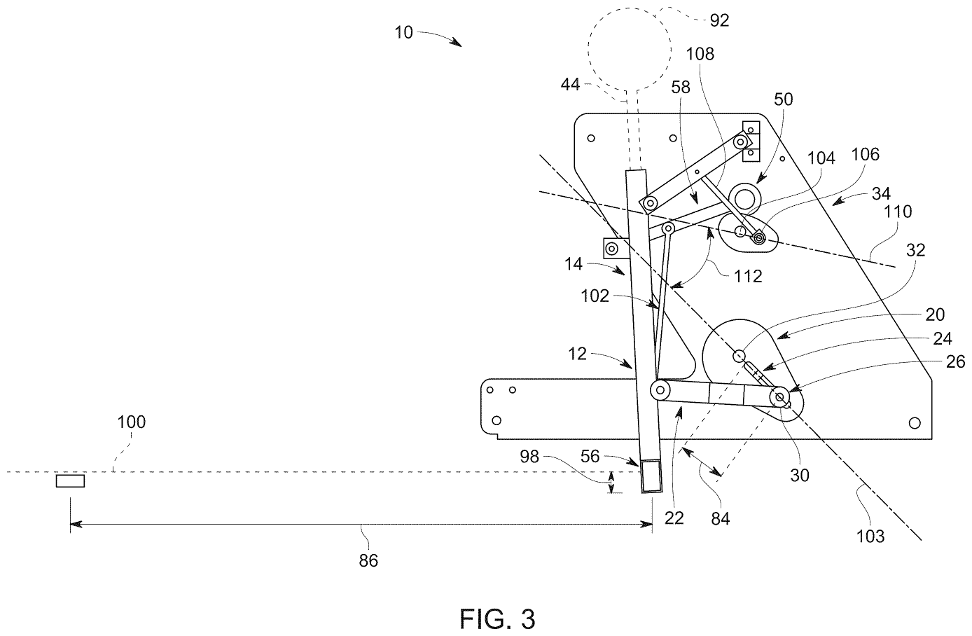

FIG. 3 depicts a schematic view of the portion of the planting apparatus 10 of FIG. 2 in a second position. The second position illustrates at least the first cam 20, the second cam 52, and the hollow shaft 14 in at least different locations when compared to the first position of FIG. 2. While in the second position, the first stitch length 86 remains the same because the position of the first end 28 of the first arm 22 within the slot 24 and the first slot distance 84 remains the same.

In the second position, the distance 98 from the surface reference line 100 to the sharpened tip 96, assuming the downward direction to be a negative direction, is less than or equal to zero. That is, when the adjustable cam assembly 12 is in the second position, the sharpened tip 96 is at or beneath the surface reference line 100.

Optionally, the second position can be defined at a maximum extension defined when the sharpened tip 96 is farthest below the surface reference line 100, or when the magnitude of the negative distance 98 is greatest. That is, the second position can be defined as the lowest point of the downstroke of the hollow shaft 14 and the gate 56 in which the downward motion of the hollow shaft 14 or the gate 56 changes to an upward motion. It is contemplated that any part of the stroke of the hollow shaft 14 and the gate 56 in which the distance 98 is a zero or negative value (a stitch is being produced), can be considered the second position.

The delivery assembly 50 is configured to move the gate 56 between an open position and a closed position. For example, the timing arm 58 of the delivery assembly 50 can be operably coupled to the gate 56. However, other mechanisms for opening and closing the gate 56 can be utilized. When within a threshold (e.g., 15%) of the maximum extension of the hollow shaft 14, the timing arm 58 contacts the second cam 52. For example, a stroke length can be measured from the sharpened tip 96 at the maximum extension to the sharpened tip 96 the maximum retraction, where in the gate 56 is opened when the sharpened tip 96 is within 15% or less of the stroke length from the maximum extension. The contact force applied to the timing arm 58 from the second cam 52 is mechanically transferred through a series of levers 102 to the gate 56, such that when the timing arm 58 experiences a predetermined force for a predetermined time, the gate 56 is in the open position. When the gate 56 is in the open position, the one or more seeds provided to the gate 56 are released within the stitch.

A first cam line 103 extends through the first point of rotation 30 and the second point of rotation 32.

A pivot illustrated as a fourth point of rotation 104 is defined as the point about which the second cam 52 rotates relative the frame 34. A fifth point of rotation 106 is defined at the rotatable coupling of the second cam 52 and a drive arm 108. A second cam line 110 extends through the fourth point of rotation 104 and the fifth point of rotation 106.

An angle 112 is defined between the first cam line 103 and the second cam line 110. The angle 112 between the first cam line 103 and the second cam line 110 is in a range of +/−40°, when the gate 56 is in the open position. For example, the angle 112 between the first cam line 103 and the second cam line 110 is in a range of 20° to 40°, inclusive of endpoint, when the gate 56 is in the open position. This range ensures the gate 56 opens at the maximum extension. That is, the one or more seeds are released at the bottom of the stroke. For example, the angle between the first cam line 103 and the second cam line 110 can be in a range of 25° to 35°, inclusive of endpoints. The smaller ranges provide an additional benefit to increased accuracy of ensuring the one or more seeds are released at the maximum extension and that debris cannot enter the gate 56 or the hollow shaft 14. By way of further example, the angle 112 between the first cam line 103 and the second cam line 110 can be in a range of 27° to 33°, inclusive of endpoint, when the gate 56 is in the open position.

It is further contemplated that the gate 56 can be in the closed position when the angle 112 is equal to or greater than 0° and less than 20° and angles greater than 40° and less than or equal to 360°, where 360° degrees is the same location or equal to 0°.

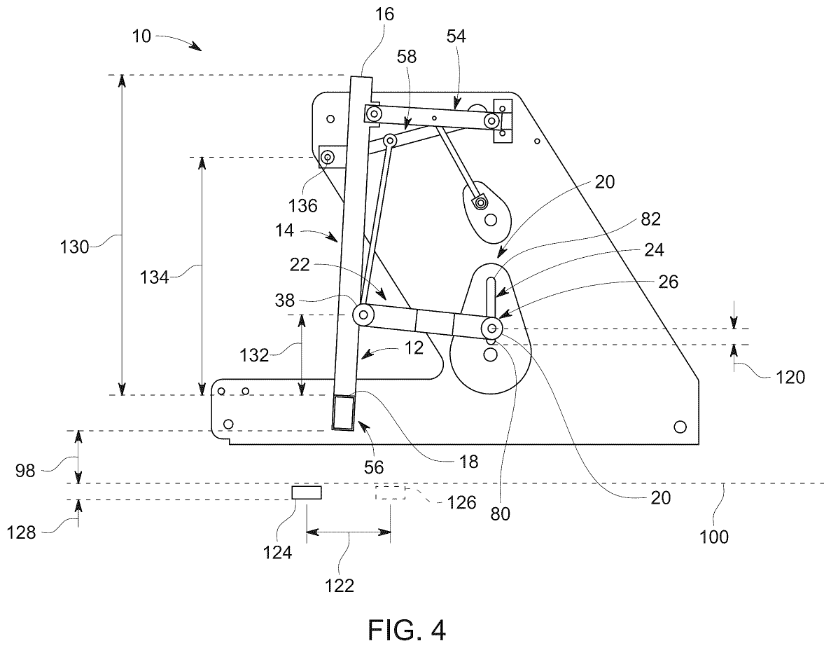

FIG. 4 depicts a schematic view of a portion of the planting apparatus 10. FIG. 4 is similar to FIG. 2, where the adjustable cam assembly 12 is in a first position. However, FIG. 4 illustrates the first end 28 of the first arm 22 coupled to the first cam 20 along the slot 24 at a second slot distance 120. The second slot distance 120 corresponds to a second stitch length 122. For example, the second slot distance 120 is shorter than the first slot distance 84 (FIG. 3), which provides the second stitch length 122 as shorter than the first stitch length 86 (FIG. 3).

The second stitch length 122 is illustrated between a geometric center of a first stitch 124 already produced by the planting apparatus 10 and a geometric center of a second stitch 126 illustrated, by way of example, as the next stitch to be produced by the planting apparatus 10. In other words, the second stitch length 122 is measured between adjacent stitches. It is contemplated that the second stitch length 122 can be measured from the leading edge or trailing edge of the first stitch 124 to a corresponding leading edge or trailing edge of the second stitch 126, where the first stitch 124 and the second stitch 126 are consecutive or adjacent stitches.

The first stitch length 86 (FIG. 2) and the second stitch length 122 can be in a range of 2 inches to 30 inches (5.08 centimeters to 76.2 centimeter), inclusive of endpoints. It is contemplated that the position of the fastener assembly 26 or the location of the coupling of the first arm 22 and the first cam 20 within the slot 24 can be adjusted to produce multiple stitch lengths in the range of 2 inches to 30 inches (7.62 centimeters to 76.2 centimeters), inclusive of endpoints. For example, the stitch length of the planting apparatus 10 can be in a range of 4 inches to 27 inches (10.16 centimeters to 68.58 centimeters), inclusive of endpoints.

The multiple stitch lengths with the gate 56 opening at the bottom of each stroke is possible, in part, by the length of the hollow shaft 14, illustrated as a shaft length 130. The shaft length 130 can be measured from the first end 16 to a second end 18 of the hollow shaft 14. However, it is contemplated that the shaft length 130 can be measured from the first end 16 to the gate 56. The shaft length 130 allows the rotatable coupling of the first arm 22 and the hollow shaft 14 to be appropriately spaced from the rotatable coupling of the timing arm 58 and the rotatable coupling of the second arm 54 such that the timing arm 58 releases the one or more seeds at the maximum extension regardless of the stitch length/position of the fastener assembly 26 along the slot 24.

A first rotation distance 132 can be measured between the gate 56 or the second end 18 of the hollow shaft 14 and the third point of rotation 38. A second rotation distance 134 can be measured from the gate 56 or the second end 18 of the hollow shaft 14 to the sixth point of rotation 136 defined by the rotatable coupling of the hollow shaft 14 and the timing arm 58. The second rotation distance 134 is, for example, greater than 6 inches (15.24 centimeters). It is contemplated that the length of the hollow shaft 14 can be lengthened such that the first rotation distance 132 and the second rotation distance 134 increase to increase the stitch length beyond 30 inches. That is, scaling of the planting apparatus 10 is contemplated.

The first stitch 124 and the second stitch 126 have a stitch depth 128. The stitch depth 128 is measured from the surface reference line 100 to its deepest point in the ground, or a point in the stitch farthest from the surface reference line 100. The first stitch 124 and the second stitch 126 will have the same stitch depth 128 unless the adjustable depth assembly 60 is repositioned between the stitches. The stitch depth 128 can, for example, be in a range of 1 inch to 6 inches (2.54 centimeters to 15.24 centimeters), including endpoints.

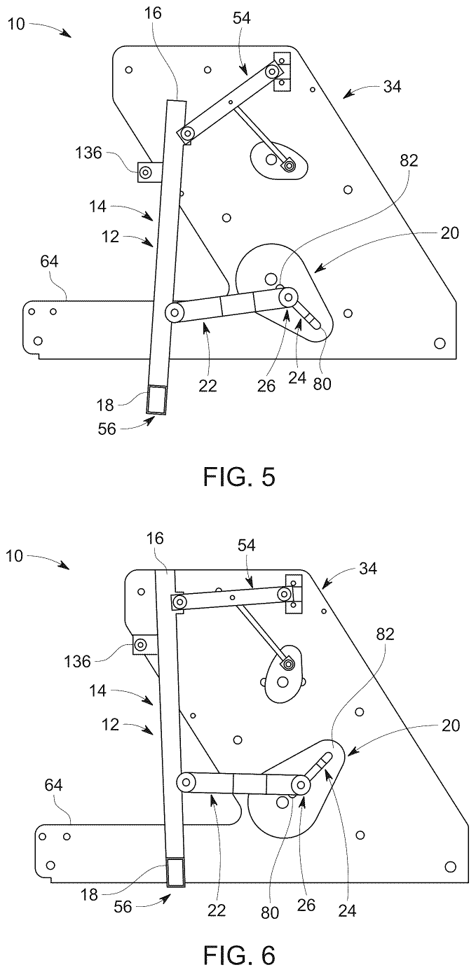

FIG. 5 depicts a schematic view of the portion of the planting apparatus 10 of FIG. 4 in a second position. The adjustable cam assembly 12 is configured to provide the second stitch length 122.

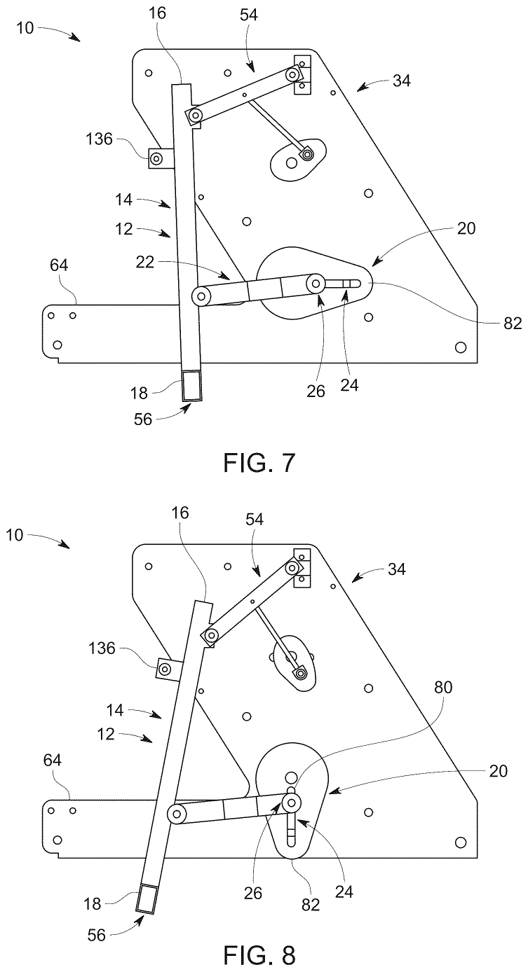

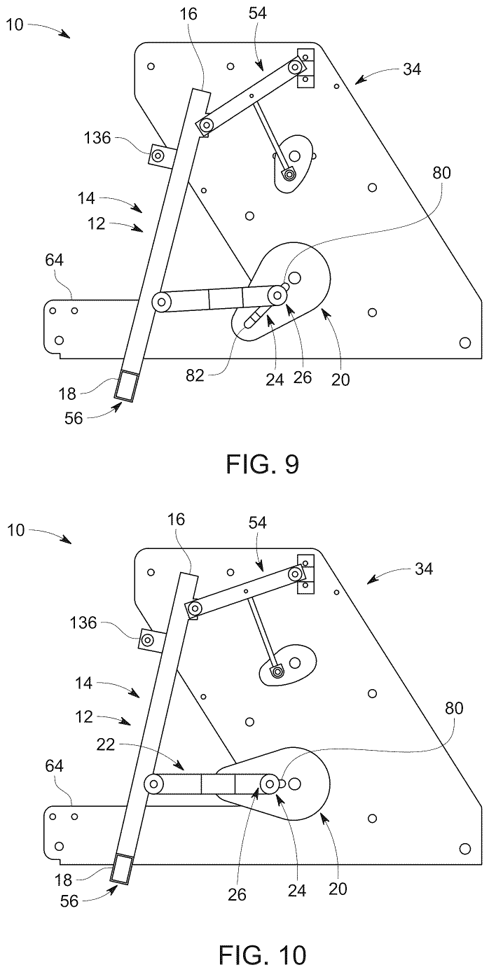

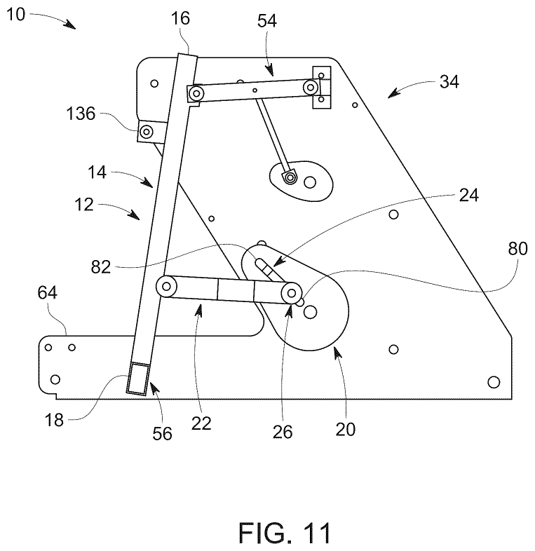

FIG. 6-FIG. 11 depicts a schematic view of the portion of the planting apparatus 10 of FIG. 4 and FIG. 5 in various positions between the first position and the second position. For example, the planting apparatus 10 moves from the first position shown in FIG. 4 to the first intermediate position shown in FIG. 6, to a second intermediate position shown in FIG. 7, to the second position shown in FIG. 5, to the third intermediate position shown in FIG. 8, to the fourth intermediate position shown in FIG. 9, to the fifth intermediate position shown in FIG. 10, to the sixth intermediate position shown in FIG. 11, and then moves back to the first position shown in FIG. 4. The driving assembly 74 directly or indirectly rotates the first cam 20 and moves the hollow shaft 14 through positions illustrated in FIGS. 4-11.

FIG. 12 depicts a schematic view of the portion of the planting apparatus 10 further illustrating the adjustable depth assembly 60. The adjustable depth assembly 60 is capable of producing multiple stitch depths 128. The adjustable depth assembly 60 can change the position of the rear portion 62 of the frame 34 and the main portion 64 of the frame 34. For example, the adjustable depth assembly 60 can change the angle 140 between the rear portion 62 of the frame 34 and the main portion 64 of the frame 34. The angle 140 can be measured between a centerline 142 of the main portion 64 of the frame 34 and a centerline 144 through the axis of the rear wheel 68. The angle 112 determines the stitch depth 128 (FIG. 4).

Referring to FIG. 1-FIG. 12, prior to operation of the planting apparatus 10, a seed type is selected and seed can be loaded into the seed metering device 92. Alternatively, a seedling type is selected and seedlings are loaded into a metering device for transplanting the seedlings.

Based on the type of seed or seedling, a predetermined stitch length is selected. The planting apparatus 10 is adjusted to the appropriate stitch length, such as the first stitch length 86 or the second stitch length 122, among others, by adjusting the fastener assembly 26 that locates the first arm 22 within the slot 24 defined by the first cam 20.

The seed type or seedling type may also be associated with a predetermined stitch depth 128. The stitch depth 128 is set using the adjustable depth assembly 60. Decreasing the angle 140 away from 180° or lowering the main portion 64 of the frame 34 increases the stitch depth 128. Increasing the angle 140 towards 180° or raising the main portion 64 of the frame 34 decreases the stitch depth 128.

During operation, the planting apparatus 10 accurately plants one or more seeds in each stitch of a series of stitches. While illustrated and described herein as planting one or more seeds, it is contemplated that the planting apparatus 10 can transplant seedlings using the same method.

The planting apparatus 10 can create the series of stitches through the protective barrier 72. The series of stitches are produced using two cams to control a swinging seed probe illustrated as the hollow shaft 14. The coupling of the first cam 20 to the first arm 22 determines the stitch distance 86, 122. As the hollow shaft 14 swings and pierces the plastic mulch film and enters the ground, it is moving at ground speed in order to create a clean hole for the seed to be deposited in and avoid pulling or stretching the plastic mulch film. This means that the hollow shaft 14 is moving at the same speed relative to the ground as the frame 34 of the planting apparatus 10 is moving relative to the ground. This is done by adjusting the input shaft speed with gearing or a hydraulic motor as part of the driving assembly 74. The seed door illustrated as the gate 56 is opened at the very bottom of the stroke (maximum extension) by the timing arm 58 interacting with the second cam 52. Opening the gate 56 at the bottom of the stroke ensures the seed(s) is released at the bottom of the stitch and prevents dirt from entering the gate 56 or hollow shaft 14.

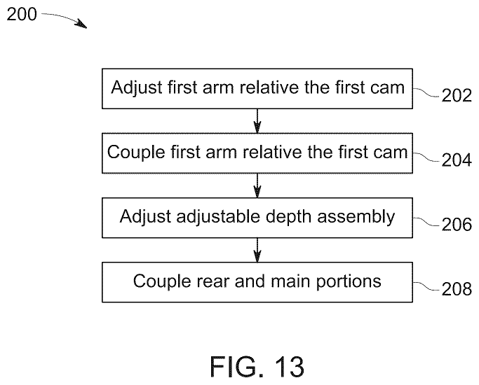

FIG. 13 illustrates a method of adjusting the planting apparatus 10 having the adjustable cam assembly 12 and the adjustable depth assembly 60. The method 200 includes, at 202, adjusting the first arm 22 to a predetermined location at the first cam 20 based on a predetermined stitch length 86, 122. At 204, after adjusting at 202, the first arm 22 and the first cam 20 are rotatably coupled. The fastener assembly 26 can be used to rotatably couple the first arm 22 and the first cam 20 such that the relative position in the slot 24 remains the same. That is, the slot distance 84, 120 is maintained by the fastener assembly 26 during operation of the planting apparatus 10.

At 206, the adjustable depth assembly 60 is adjusted to a predetermined stitch depth. The stitch depth 128 corresponds to the angle 112 between the rear portion 62 of a frame 34 and the main portion 64 of the frame 34, therefore the adjusting can include changing the angle 112 indicative of the predetermined stitch depth.

At 208, after the adjusting at 206, the rear portion 62 and the main portion 64 of the frame 34 are fastened or securely coupled. When coupled, the angle 112 between the rear portion 62 and the main portion 64 is maintained during operation of the planting apparatus 10.

While described herein as planting seeds or seedlings, it is contemplated that the planting apparatus 10 can be used as a dibbler.

Benefits of aspects of the disclosure include a single planting apparatus capable of planting a series of stitches at multiple stitch lengths. Further, the depth of each stitch of the series of stitches can be adjusted.

This is a long-felt need in the industry as traditionally, changing the stitch length required significant reconfiguration of the planting apparatus or simply required more than one planting apparatus or attachment. Without removing or adding pieces, the planting apparatus disclosed herein provides multiple stitch lengths and multiple stitch depths. This allows a user to plant a wide variety of crops with the same planting apparatus.

Additional benefits include the dual cam control which allows for the seeds or seedlings to be released at the maximum extension or low point of the gate or hollow shaft regardless of the stitch length.

Still yet, another benefit is that the planting mechanism can be used to plant through protective barriers such as plastic mulch without tearing or stretching the protective barrier.

To the extent not already described, the different features and structures of the various embodiments can be used in combination, or in substitution with each other as desired. That one feature is not illustrated in all of the embodiments is not meant to be construed that it cannot be so illustrated but is done for brevity of description. Thus, the various features of the different embodiments can be mixed and matched as desired to form new embodiments, whether or not the new embodiments are expressly described. All combinations or permutations of features described herein are covered by this disclosure.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Further aspects of the disclosure are provided by the subject matter of the following clauses:

A planting apparatus comprising an adjustable cam assembly comprising a hollow shaft having a first end and a second end, a first cam, and a first arm adjustably coupling the hollow shaft and the first cam to provide multiple stitch lengths.

The planting apparatus of any preceding clause, wherein the multiple stitch lengths include at least two different stitch lengths from a range of 2 inches to 30 inches, inclusive of endpoints.

The planting apparatus of any preceding clause, wherein a height of the hollow shaft is measured from the first end to the second end, and wherein the height of the hollow shaft is greater than six inches.

The planting apparatus of any preceding clause, further comprising a delivery assembly comprising a second cam, a second arm operably coupling the second cam and the hollow shaft, a gate located at the second end of the hollow shaft, and a timing arm operably coupled to the gate.

The planting apparatus of any preceding clause, wherein the timing arm is configured to move the gate between a closed position and an open position.

The planting apparatus of any preceding clause, wherein the hollow shaft moves between a first position and a second position, and wherein the gate is in the open position when the hollow shaft is within 15% of a maximum extension.

The planting apparatus of any preceding clause, wherein the angle between the first cam and the second cam is in a range of 20 degrees to 40 degrees when the gate is in the open position.

The planting apparatus of any preceding clause, wherein the timing arm couples to the hollow shaft at a sixth point of rotation.

The planting apparatus of any preceding clause, wherein the distance from the sixth point of rotation to the second end is greater than six inches.

The planting apparatus of any preceding clause, wherein the first cam couples to the first arm at a slot, wherein the position of the coupling of the first cam and the first arm within the slot determines the stitch length.

The planting apparatus of any preceding clause, further comprising a frame, wherein a main portion of the frame rotatably supports the first cam and the second cam.

The planting apparatus of any preceding clause, further comprising an adjustable depth assembly that changes the angle between the rear portion of the support assembly and the main portion of the support assembly.

The planting apparatus of any preceding clause, wherein the rear portion of the frame couples to a rotatable rear wheel and the main portion of the frame rotatably supports a front wheel.

The planting apparatus of any preceding clause, wherein the adjustable depth assembly produces multiple stitch depths.

The planting apparatus of any preceding clause, wherein the multiple stitch depths are in a range of 1 inch to 6 inches, including endpoints.

The planting apparatus of any preceding clause, wherein the adjustable depth assembly includes an angle measured between a centerline of a main portion of the frame and a centerline through an axis of a rear wheel supported by a rear portion of the frame, and wherein the angle determines the stitch depth.

The planting apparatus of any preceding clause, wherein the gate includes a sharpened tip.

The planting apparatus of any preceding clause, wherein the seed metering device is configured to provide one, two, or three seeds to the hollow shaft when the gates are in the closed position.

The planting apparatus of any preceding clause, further comprising a metering device configured to provide a seedling to the hollow shaft when the gates are in the closed position.

The planting apparatus of any preceding clause, further comprising a driving assembly having one or more of a drive wheel, gear assembly, or gear train.

A method of adjusting the planting apparatus, wherein the planting apparatus further comprises an adjustable depth assembly, the method comprising adjusting the first arm to a predetermined location at the first cam based on a predetermined stitch length, rotatably fastening, after adjusting, the first arm and the first cam, adjusting, via the adjustable depth assembly, the angle between a rear portion of a frame and a main portion of the frame to a predetermined angle indicative of a predetermined stitch depth, and fastening, after adjusting, the rear portion and the main portion of the frame.

What is claimed is:

1. A planting apparatus comprising:
an adjustable cam assembly comprising:
a hollow shaft having a first end and a second end;
a first cam; and
a first arm adjustably coupling the hollow shaft and the first cam to provide multiple stitch lengths.

2. The planting apparatus of claim 1, wherein the multiple stitch lengths include at least two different stitch lengths from a range of 2 inches to 30 inches, inclusive of endpoints.

3. The planting apparatus of claim 1, wherein a height of the hollow shaft is measured from the first end to the second end, and wherein the height of the hollow shaft is greater than six inches.

4. The planting apparatus of claim 1, further comprising a delivery assembly comprising:
a second cam;
a second arm operably coupling the second cam and the hollow shaft;
a gate located at the second end of the hollow shaft; and
a timing arm operably coupled to the gate.

5. The planting apparatus of claim 4, wherein the timing arm is configured to move the gate between a closed position and an open position.

6. The planting apparatus of claim 5, wherein the hollow shaft moves between a first position and a second position, and wherein the gate is in the open position when the hollow shaft is within 15% of a maximum extension.

7. The planting apparatus of claim 5, wherein an angle between the first cam and the second cam is in a range of 20 degrees to 40 degrees when the gate is in the open position.

8. The planting apparatus of claim 4, wherein the timing arm couples to the hollow shaft at a sixth point of rotation.

9. The planting apparatus of claim 8, wherein a distance from the sixth point of rotation to the second end is greater than six inches.

10. The planting apparatus of claim 1, wherein the first cam couples to the first arm at a slot, wherein a location of the coupling of the first cam and the first arm within the slot determines a stitch length from the multiple stitch lengths.

11. The planting apparatus of claim 1, further comprising a frame, wherein a main portion of the frame rotatably supports the first cam and a second cam.

12. The planting apparatus of claim 1, further comprising an adjustable depth assembly that changes an angle between a rear portion of a frame and a main portion of the frame.

13. The planting apparatus of claim 12, wherein the rear portion of the frame couples to a rotatable rear wheel and the main portion of the frame rotatably supports a front wheel.

14. The planting apparatus of claim 12, wherein the adjustable depth assembly produces multiple stitch depths.

15. The planting apparatus of claim 14, wherein the multiple stitch depths are in a range of 1 inch to 6 inches, including endpoints.

16. The planting apparatus of claim 14, wherein the angle is measured between a centerline of the main portion of the frame and a centerline through an axis of a rear wheel supported by the rear portion of the frame, and wherein the angle determines a stitch depth of the multiple stitch depths.

17. The planting apparatus of claim 1, further comprising a gate, wherein the gate includes a sharpened tip.

18. The planting apparatus of claim 17, further comprising a seed metering device configured to provide one, two, or three seeds to the hollow shaft when the gate is in a closed position.

19. The planting apparatus of claim 1, further comprising a driving assembly having one or more of a drive wheel, gear assembly, or gear train.

20. A method of adjusting the planting apparatus of claim 1, wherein the planting apparatus further comprises an adjustable depth assembly, the method comprising:
adjusting the first arm to a predetermined location at the first cam based on a predetermined stitch length;
rotatably fastening, after adjusting, the first arm and the first cam;
adjusting, via the adjustable depth assembly, an angle between a rear portion of a frame and a main portion of the frame to a predetermined angle indicative of a predetermined stitch depth; and
fastening, after adjusting, the rear portion and the main portion of the frame.
